(19) United States
(12) Patent Application Publication
(10) Pub. No.: US 2017/0368440 A1
(43) Pub. Date: Dec. 28, 2017

(54) SPORTS EQUIPMENT CARRYING SYSTEM

(71) Applicants: Edgar E. Graham, Alvin, TX (US); Carl Franklin Graham, Bentbrook, TX (US)

(72) Inventors: Edgar E. Graham, Alvin, TX (US); Carl Franklin Graham, Bentbrook, TX (US)

(21) Appl. No.: 15/631,492

(22) Filed: Jun. 23, 2017

Related U.S. Application Data
(60) Provisional application No. 62/353,717, filed on Jun. 23, 2016.

(51) Int. Cl. A63B 71/00; B62B 3/10; A63B 60/60; A63B 71/02

(52) U.S. Cl. CPC A63B 71/0045; B62B 3/10; A63B 60/60; A63B 2071/025; B62B 2202/40

(57) ABSTRACT

A sport equipment carrying system that allows items such as baseball bats, balls, or rackets to be carried, organized and stored. The system has an ice chest to carry drinks or food to be consumed while participating in sporting events. The ice chest is attached to an external enclosure via a snap-on frame.

### BACKGROUND

### 1. Field of the Invention

The present invention relates generally to sporting equipment carrying systems, and more specifically, to a sporting equipment carrying system which attaches to a portable cooler.

### 2. Description of Related Art

Sporting equipment carrying systems are known in the art and provide a viable means of storing sporting items for transport. In FIG. 1, a commonly known sporting equipment carrying system 101 is shown. System 101 includes a bag compartment 103 with an upper opening which commonly secured using a zipper. The portable storage system 101 is commonly carried using one or more shoulder straps 105 or by grabbing the hand strap 107. Items can be stored inside the bag compartment 103 and easily transported using the shoulder straps 105 allowing for hands-free operation.

Users of conventional sporting equipment carrying systems similar to that shown in system 101 commonly store and transport cold drinks in the carrying system. Cold and hot drinks are oftentimes desirable at sporting events; hence, users conveniently store them in the carrying system for later consumption. The refreshments commonly change to ambient temperature due to the lack of insulation in the carrying system. This is viewed as a disadvantage of conventional carrying systems. Alternatively, individuals sometimes use a portable cooler to store the cold drinks while using the sporting equipment carrying system to store the sporting items. Traveling to sports games with both equipment carrying systems and bulky portable coolers can be undesirable and physically difficult. This is viewed as another disadvantage of conventional carrying systems.

Although great strides have been made in the area of sport equipment carrying systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an oblique view of a conventional sport equipment carrying system;

FIG. 2 is an oblique view of a sport equipment carrying system in accordance with a preferred embodiment of the present application;

FIG. 3 is an oblique view of the sport equipment carrying system given in FIG. 2; and

FIG. 4 is an oblique view of a sport equipment carrying system in accordance with an alternate embodiment of the present application.

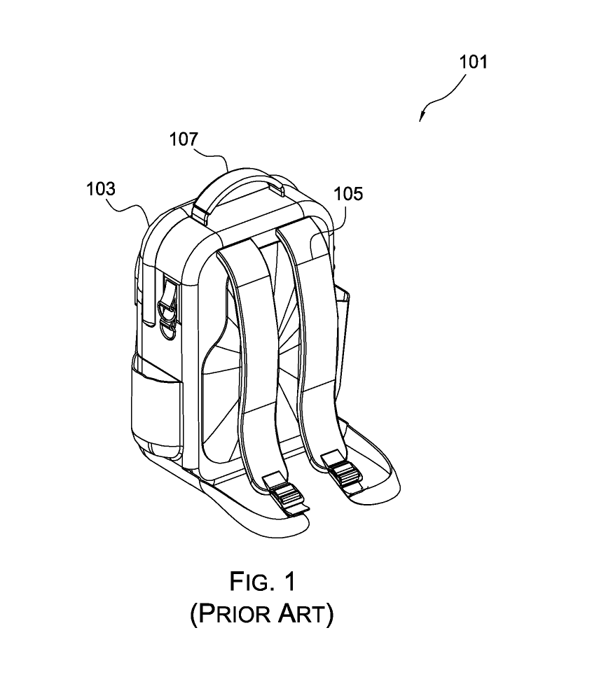

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional sport equipment carrying systems. Specifically, the system of the present application provides the user with a sport equipment carrying system which attaches to a portable cooler system. The sport equipment carrying system includes many features for storing sports items and accessories including, but not limited to, gloves, cleats, bats, helmets, cans, balls, and other dry storage items. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

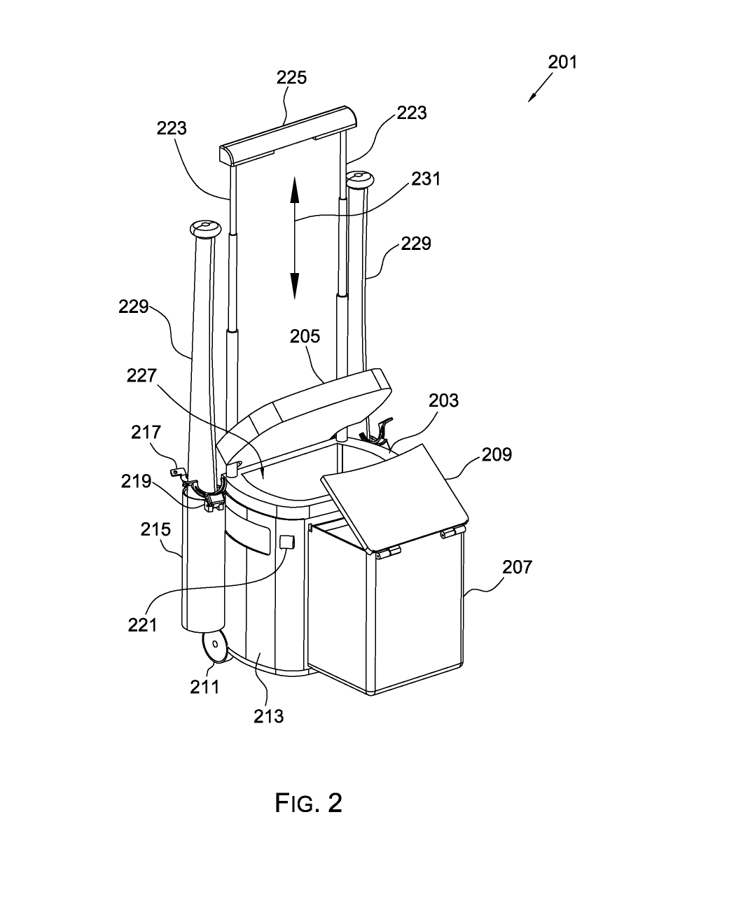

Referring now to the drawings wherein like reference characters identify corresponding or similar elements throughout the several views, FIG. 2 depicts a sport equipment carrying system in accordance with a preferred embodiment of the present application. It will be appreciated that system 201 overcomes one or more of the above-listed problems commonly associated with the conventional sport equipment carrying systems.

In a preferred embodiment, system 201 includes a cooler body 203 with pivoting and removable lid 205 which form an insulated enclosure for storing cold or hot items. The formed, insulated enclosure surface 227 is sealed such that liquid can be safely stored internally without leaking. The insulated walls are configured such that heat transfer is minimized and the internal, enclosed temperature can be retained for long periods of time.

An external enclosure body 207 with pivoting lid 209 are attached to the snap-on frame 213. The snap-on frame 213 formably attaches to the cooler body 203 and provides a lightweight mounting surface for many of the unique features of system 201. The external enclosure body 207 and lid 209 are configured to form a bin which provides a means of storing various equipment such as gloves, hats, etc. This is viewed as an advantage of the system of the present application. It is appreciated that the external enclosure lid 209 could be excluded in an alternate embodiment.

One or more wheels 211 are attached to the insulated enclosure body 203 which provide a means of easily moving system 201. Additionally, one or more telescoping shafts 223 are mechanically attached to the insulated enclosure body 203 and are connected by handle 225. The telescoping shafts 223 can be extended or collapsed linearly in direction 231 for the user's convenience and ergonomic preference. The handle 225 provides a comfortable grip for the user to hold while moving system 201. This is viewed as an advantage of the system of the present application.

As depicted in FIG. 2, one or more bat holders 215 are attached to the snap-on frame 213. One or more bat clamps 217 are pivotably attached to the bat holders 215 and provide a means of positively retaining a bat in the bat holder 215 and securing with a lock. One or more hooks 221 are attached to the snap-on frame 213 and provide a means of hanging sports gear, e.g. shoes or cleats, using the laces near the toe of the shoe.

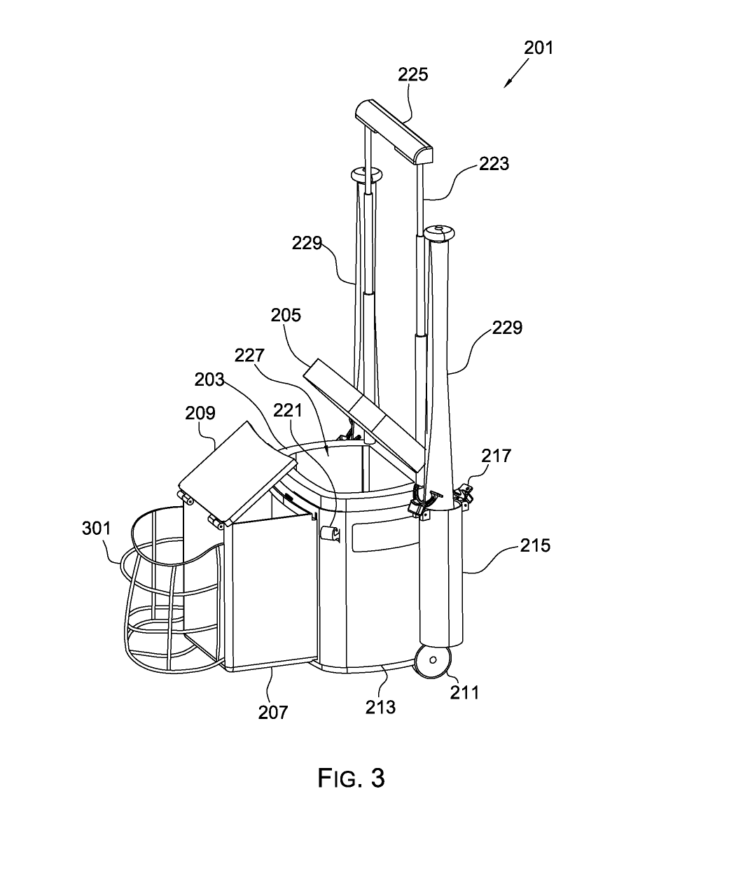

Referring now to FIG. 3, an oblique view of system 201 is respectively shown. A storage bag 301 is attached to the external enclosure body 207. The storage bag 301 is depicted as an elastic mesh composition; however, it is appreciated that the removable storage bag could be a solid vinyl or fabric material in an alternate embodiment. The storage bag 301 provides a configurable means of storing many other items such as helmets, basketballs, footballs, etc. Additionally, the open top storage bag 301 provides quick access to the stored goods. This is viewed as an advantage of the system of the present application.

Referring now to FIG. 4, an oblique view of system 401 is respectively shown in accordance with an alternative embodiment of the present application. System 401 is substantially similar in function to system 201 and it is contemplated interchanging the features of the different types of the systems discussed herein.

In an alternative embodiment, system 401 includes a modular, snap-on frame 403 which formably attaches to a wide variety of cooler bodies and provides a lightweight mounting surface for many of the unique features of system 401. System 401 is configured to be customizable, modular, and to quickly attach to many existing portable cooler types. One or more external enclosure bodies 407 and lids 409 are configured to form a bin which provides a means of storing various equipment such as gloves, hats, etc. Similar to system 201, system 401 contains many unique features such as bat holders 413, equipment hooks, 411, and bat retainers 415 and 417. It is appreciated that the arrangement of these unique features located on the snap-on frame 403 can be varied.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A sport equipment carrying system comprising:
a cooler body having a snap-on frame;
wherein at least one external enclosure is removably attached to the snap-on frame; and
wherein beverages are stored in the cooler body and equipment is stored in the external enclosure.

2. The system of claim 1 wherein the external enclosure includes a lid.

3. The system of claim 1 wherein at least on hook is attached to the snap-on frame.

4. The system of claim 1 wherein wheels are attached to the snap-on frame.

5. The system of claim 1 wherein a telescoping handle is attached to the snap-on frame.

6. The system of claim 1 wherein at least on bat holder is attached to the snap-on frame.

7. The system of the claim 6 wherein clamps are attached to retain a baseball bat in the bat holder.

8. The system of claim 1 wherein the external enclosure is a storage bag.
